(19) United States
(12) Patent Application Publication
(10) Pub. No.: US 2021/0010710 A1
(43) Pub. Date: Jan. 14, 2021

(54) System of Couplers for Connecting Flexible Ducting of Forced Air Systems

(71) Applicant: Robert Daniel OBERLANDER, Frederick, MD (US)

(72) Inventor: Robert Daniel OBERLANDER, Frederick, MD (US)

(21) Appl. No.: 16/924,826

(22) Filed: Jul. 9, 2020

Related U.S. Application Data
(60) Provisional application No. 62/871,912, filed on Jul. 9, 2019.

(51) Int. Cl. F24F 13/02; F16L 37/098; F16L 3/12

(52) U.S. Cl. CPC F24F 13/0209; F16L 37/098; F24F 13/0281; F24F 13/0218; F24F 13/0254; F16L 3/1222

(57) ABSTRACT

A stabilizer component comprising a unitary body including a central flange, a plurality of first and second retention stanchions. The central flange defines a through-hole from a first end portion to a second end portion of the stabilizer component, and includes an inner circumference and an outer circumference. Each first retention stanchion, of the plurality of first retention stanchions, (i) extends orthogonally and outwardly from the outer circumference of the central flange in a first direction, and (ii) is configured to be inserted into a respective receiving slot of a first HVAC connecting component. Each second retention stanchion, of the plurality of second retention stanchions, (i) extends orthogonally and outwardly from the outer circumference of the central flange in a second direction, said second direction being opposite said first direction, and (ii) is configured to be inserted into a respective receiving slot of a second HVAC connecting component.

### FIELD OF THE INVENTION

The present disclosure relates to central heating and cooling using flexible ducting as a means of air distribution. More particularly the present invention relates to a system of connectors and an installation value of installing couplers that connect flexible ducting to source hardware.

### BACKGROUND OF THE INVENTION

Flexible ducts are typically made of flexible plastic over a metal wire coil and configured to have a tubular shape body. The flexible ducts are convenient for use in multiple applications including heating, ventilating and air conditioning (HVAC) systems and air discharging purposes as they can quickly and easily connect with the respective devices.

Typical HVAC systems include sections of ductwork extending from the heating and air conditioning equipment to additional air handling equipment or to distribution devices. The sections of ductwork may include multiple flexible duct sections which are connected by a plurality of couplers (also referred to as “connectors”). Such couplers may be comprised of sheet metal or plastic. A problem with conventional sheet metal (or plastic) couplers, which connect such flexible ducting, however, is that they require tape glue, and usually self-tapping screws, to connect duct liners to smooth and slippery coupler neck surfaces. The difficulty in installing these connectors sometimes causes improper installation in which flexible ducting is twisted into small spaces, thrown over rafters, and generally misused. Some installers forgo proper installation when having to reach into small and/or hot spaces to connect liners to couplers.

Another problem associated with traditional sheet metal couplers and, more specifically, with the installation of flexible ducting with conventional sheet metal couplers, is slippage from the coupling. Since sheet metal is smooth and retention ridges are simply crimped into the necks of the couplers, spiral support wire within the liner slips over the retention ridges, and the liner slips from the coupling. This results in air leaking into space short of its intended target. The Department of Energy estimates that air leaks are approximately 25-30 percent of the heating and cooling load for a typical home.

Yet another problem with sheet metal couplers involves the loss of heat and cold when traveling through the sheet metal itself. Because of its high thermal conductivity (i.e., low heat transferability), metal provides very little resistance to the flow of thermal energy (heat). Thus, due to its conductive nature, sheet metal couplers are inefficient for containing heat. On the contrary, plastic materials have a low thermal conductivity (i.e., low heat transferability) compared to metal and, thus, are usually good insulators. Even further, metal couplers have a tendency to rust and/or corrode when moisture enters the ducting system. Over time, metal couplers can degrade to the point of unviability in connecting flexible ducting.

A further problem relating to metal duct couplers is that they collect dust and dirt on their surfaces. In high humidity environments, a surface of a sheet metal coupler sweats, and the moisture traps dust and dirt. This results in mold and mildew forming internally in the duct couplers. Plastic couplers, on the contrary, can be manufactured with additives that fight the formation of mold and mildew.

Thus, there is a need for an improved HVAC component system including individual snap-together fittings configured for use with flexible ductwork and configured to efficiently deliver air from a source to distribution points that significantly reduces losses of heat and air.

### SUMMARY

The present disclosure provides a description of a system and method of connectors configured to connect flexible ducting to a plenum and distribute air to multiple distribution points. A stabilizer component is configured to securely couple two heating, ventilating and air conditioning (HVAC) system components together, the stabilizer component comprising a unitary body including a central flange, a plurality of first retention stanchions, and a plurality of second retention stanchions. The central flange defines a through-hole from a first end portion of the stabilizer component to a second end portion of the stabilizer component, and includes an inner circumference and an outer circumference. Each first retention stanchion, of the plurality of first retention stanchions, (i) extends orthogonally and outwardly from the outer circumference of the central flange in a first direction, and (ii) is configured to be inserted into a respective receiving slot of a first HVAC connecting component. Each second retention stanchion, of the plurality of second retention stanchions, (i) extends orthogonally and outwardly from the outer circumference of the central flange in a second direction, said second direction being opposite said first direction, and (ii) is configured to be inserted into a respective receiving slot of a second HVAC connecting component.

A takeoff configured to transfer air from a duct section extending from a plenum of a heating, ventilating and air conditioning (HVAC) system to a plurality of flexible ducting section. The takeoff includes a first base portion, a second base portion, and a throat portion. The first base portion is removably connected to a first section of ducting of a plurality of ducting sections and includes a flange face that defines a center hole and further defines a plurality of slots extending therethough. Each slot of the plurality of slots defined by the first base portion is configured to receive a respective retention stanchion of stabilizer component. The second base portion is aligned over an opening defined in a surface of the duct section extending from the plenum and is removably coupled to the surface of the duct section. The throat portion extends between the first base portion and the second base portion and defines an air tunnel from the center hole of the first base portion to the opening defined in the surface of the duct section. The second base portion is disposed orthogonally to and extends from the throat portion and defines a plurality of slots. Each slot of the plurality of slots defined by the second base portion is configured to receive a respective retention stanchion of a stabilizer component having a unitary body that connects from within and below the surface of the duct section.

An end coupler component removably coupleable to two heating, ventilating and air conditioning (HVAC) system components. The end coupler component comprises a first end portion, a second end portion, and a neck portion. The first end portion includes a flange face and defines a first opening. The second end portion, opposite said first end portion, defines a second opening. The neck portion extends between the first end portion and the second end portion and defines a through-hole fluidly connected between the first opening defined by the first end portion and the second opening defined by the second end portion. The flange face of the first end portion extends along an outer circumference of the neck portion and defines a plurality of slots, each slot of the plurality of slots being configured to receive a respective retention stanchion of a stabilizer component. The second end portion is configured to be inserted into a duct liner of a section of flexible ducting such that the duct liner covers an outer periphery of at least a portion of the neck portion. The second end portion also includes a duct liner retention barb configured to secure the duct liner to the neck portion.

A system for distribution of air from a central plenum to multiple distribution points. The system includes a stabilizer component, a takeoff component, and an end coupler component. The stabilizer component includes (i) a plurality of first retention stanchions extending orthogonally and outwardly from an outer circumference of a central flange in a first direction, and (ii) a plurality of second retention stanchions extending orthogonally and outwardly from the outer circumference of the central flange in a second direction. The takeoff component includes a flange face defining a plurality of slots extending therethrough, wherein each slot of the plurality of slots defined by the flange face is configured to receive a respective first retention stanchion of the plurality of first retention stanchions of the stabilizer component. The takeoff component also includes a base portion aligned over an opening defined in a surface of the duct section extending from the plenum and removably coupled to the surface. The end coupler component includes a first end portion defining a plurality of slots, each slot of the plurality of slots of the end coupler component being configured to receive a respective second retention stanchion of the plurality of second retention stanchions of the stabilizer component. The end coupler component also includes a second end portion configured to be inserted into a duct liner of a section of flexible ducting.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 is a perspective view of a system for distributing air from a central air unit to various distribution points using snap together, plastic HVAC components, in accordance with exemplary embodiments.

FIG. 2A-2B are perspective views of a straight takeoff and a bulkhead stabilizer component, in accordance with exemplary embodiments.

FIGS. 3A-3C illustrate perspective views of an end coupler, a stabilizer component, and an end coupler assembly, respectively, in accordance with exemplary embodiments.

FIG. 4 illustrates a perspective view of a securement of a flexible duct liner to an end coupler neck, in accordance with exemplary embodiments.

FIG. 5 illustrates a perspective view of an indoor air quality (IAQ) device that snaps into a system of couplers, in accordance with exemplary embodiments.

FIGS. 6A-6B illustrate perspective views of preferred structures of the stabilizer component in accordance with exemplary embodiments.

FIG. 7 illustrates a duct, device, and zone relationship in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosures.

### DETAILED DESCRIPTION

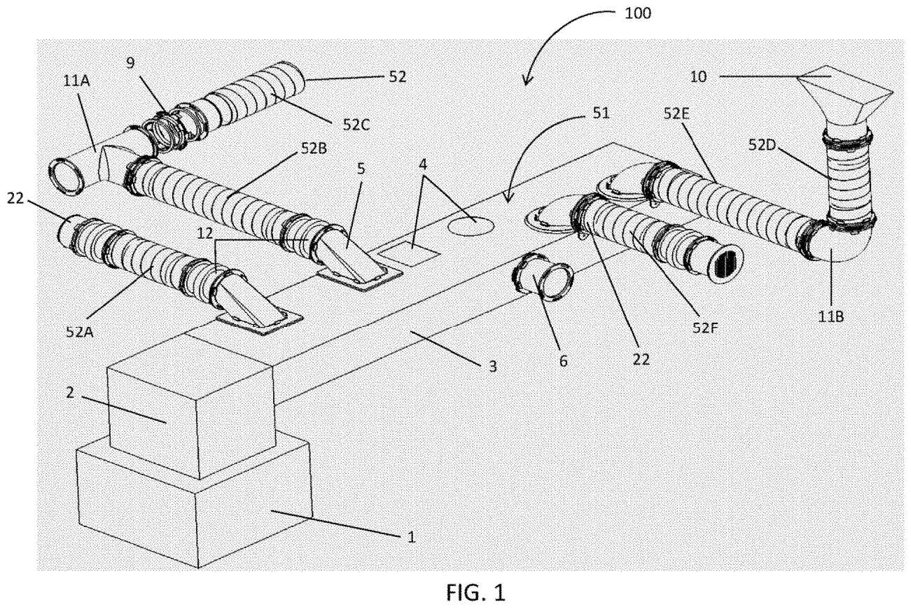

FIG. 1 illustrates a heating and cooling system 100 for distributing air from a central air unit to various distribution points using snap together, plastic HVAC components.

### The System

The heating and cooling system 100 of FIG. 1 includes an HVAC equipment 1 (e.g., furnace), a supply plenum 2 (herein referred to as “plenum”), a duct 3, and a plurality of ducting sections 52. The plenum 2 is an air-distribution box that is attached directly to a supply outlet (not depicted) of the HVAC equipment 1. The duct 3 connects to an outlet of the plenum 2 and extends outwardly therefrom. The HVAC equipment 1 forces heated or cooled air (via a blower) into the plenum 2 and, from the plenum 2, to the duct 3 and the plurality of ducting sections 52. A duct surface 51 (also referred to herein as “duct wall”) of the duct 3 also defines duct openings 4 for transferring air within the duct 3 to the flexible ducting, via a takeoff. The duct openings 4 are created with cuts on the duct wall 51 and may be of a circular shape, square shape, or any other suitable shape for the transferring of air.

### The Takeoff/Collar

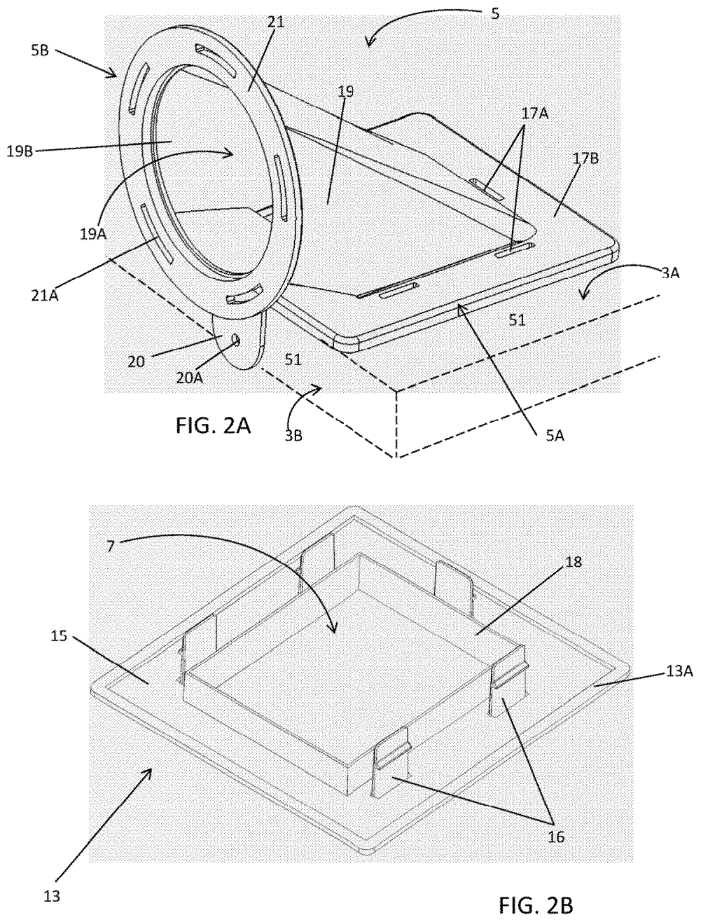

A takeoff provides a transition from the flat duct surface 51 to a section of the plurality of ducting sections 52 and defines an air tunnel 19A (takeoff throat) therethrough for transferring air from the duct 3 to the plurality of ducting sections 52. A takeoff may include, for example, straight takeoff 5 (discussed in more detail with respect to FIG. 2A) and 90-degree takeoff 6. Each takeoff, for example, the straight takeoff depicted in FIG. 2A, includes a first end portion 5A removably connected to the duct 3, and a second end portion 5B removably connected to the section of plurality of ducting sections 52.

The plurality of ducting sections 52 may include multiple flexible and/or rigid duct sections (for example, flexible sections 52A-52F, though not limited thereto), which are connected by a plurality of couplers (also referred to as “connectors”). The plurality of couplers may include, but are not limited to, square and circular takeoffs, end couplers, stabilizers, T-couplers, Wye couplers, 90-degree and 45-degree couplers, end caps, register boots, registers, electrified couplers with drop in pod capabilities, formed of a plastic unitary body. The unitary body is designed for connection to flexible ducting. The plurality of ducting sections 52 ultimately leads to at least one register (not shown) via a register boot 10.

As such, the heating and cooling system 100 efficiently delivers air from the HVAC equipment 1 to the at least one register 10 via the duct 3, takeoffs, 5, 6, plurality of ducting sections 52, and register boot 10.

FIG. 2A depicts a straight takeoff 5 of FIG. 1 configured to securely connect to a bulkhead stabilizer component (e.g., stabilizer 13 of FIG. 2B). A 90-degree takeoff 6 (also referred to as a “collar”) has a similar structure and, thus, for conciseness, further discussion thereof is not provided. As previously discussed, a takeoff (e.g., straight takeoff 5) provides a transition from the flat duct surface 51 to a first section 52A (shown in FIG. 1) of the plurality of ducting sections 52 and defines the air tunnel 19A therethrough for transferring air from the duct 3 to the plurality of ducting sections 52.

The first end portion 5A of the takeoff 5 is removably connected to the duct 3, via a stabilizer 13 and a gasket bed 15, and defines a first opening (not shown). The first opening may be defined as a 90 degree square opening, a round opening, or any other suitable opening. The first end portion 5A also includes a base portion 17B. The base portion 17B defines a plurality of slots 17A therethrough configured to receive retention stanchions 16 of the stabilizer 13 (discussed in more detail herein).

The second end portion 5B of the takeoff 5 defines a second opening 19B and is removably connected to the first section 52A of plurality of ducting sections 52. The air tunnel 19A (takeoff throat) is defined by walls 19 of the takeoff 5 and extends between the first opening (not shown) and the second opening 19B

The stabilizer 13, as depicted in FIG. 2B, is removably coupleable to the base portion 17B of the first end portion 5A of the takeoff 5 of FIG. 2A and includes a male protrusion 18, a plurality of retention stanchions 18 and a stabilizer flange 13A.

The male protrusion 18 of the stabilizer extends orthogonally and outwardly therefrom and is configured to be inserted into the air tunnel 19 (takeoff throat) of the takeoff 5. The male protrusion 18 of the stabilizer 13 further defines a through-hole 7 through a middle portion of the stabilizer. In one embodiment, the male protrusion 18 may be in a 90 degree square configuration (for insertion into a square air tunnel) defining a square through hole 7 (as depicted in FIG. 2B). In other embodiments, the male protrusion may be a round configuration (for insertion into a round air tunnel) defining a round through hole. Other configurations are possible depending on the configuration and shape of the air tunnel in which it is to be inserted.

The plurality of retention stanchions 16 of the stabilizer 13 extend orthogonally and outwardly therefrom. The plurality of retention stanchions 16 extend from the stabilizer 13 along an outer perimeter of and in a direction parallel to the male protrusion 18. The plurality of retention stanchions 16 are configured to be inserted into the plurality of slots 17A formed in the base 17B of the takeoff 5 to secure the takeoff 5 to the stabilizer 13. In a preferred embodiment, each retention stanchion of the retention stanchions 16 includes a barb 16′ configured to latch, hook, snap-together, or otherwise secure the stabilizer 13 to the base 17B of the takeoff 5, via a respective slot 17A.

The stabilizer flange 13A includes a gasket bed 15 (containing a gasket, not shown) and is configured to be tightly abutted against an inside surface of the duct 3 preventing air from passing between the stabilizer flange 13A and the duct wall 51 and, thus, creating an airtight bond between the takeoff 5 and the duct 13.

To connect to the duct 3, the takeoff 5 is positioned on an outer surface of the duct wall (as shown in FIG. 1) such that the first opening of the takeoff 5 is aligned over the respective duct opening. The first portion 13A of the stabilizer 13 is positioned on an inside surface of the duct 3 such that the through hole 7 of the stabilizer 13 is aligned with the respective duct opening and first opening of the takeoff 5 and each of the plurality of retention stanchions 16 are aligned with respective slots of the plurality of slots 17A of the base 17B of the takeoff 5. The male protrusion 18 is configured to be inserted through the respective duct opening 4 and into the air tunnel 19 of the takeoff 5 such that the male protrusion 18 and an inner surface of the walls of the takeoff 5 form a continued smooth internal surface. Each of the retention stanchions 16 is configured to be inserted through the respective duct opening 4 and respective slots of the plurality of slots 17A formed in the base 17B of the takeoff 5 until the barbs of the retention stanchions 16 pass through the slots and secure the stabilizer 13 to the base 17B of the takeoff 5. Said another way, the stabilizer 13 is secured in place by the barbs of the barbed stanchions 16 hooking over the slotted base 17B of the takeoff 5, such that the stabilizer 13 and the takeoff 5 are snapped (e.g., latched) together. As a result of the barbs of the retention stanchions 16 hooking over the slotted base 17B of the takeoff 5, the stabilizer flange 13A and gasket bed 15 of the stabilizer 13 are firmly pressed against the inside surface of the duct 3.

As a result of the secure connection between the takeoff 5 and stabilizer 13 (as described above), an airtight bond is created between the takeoff 5 and the duct surface 51.

The second end portion 5B (also referred to as a front base) of the takeoff 5, as previously discussed, is removably connected to the first section 52A of plurality of ducting sections 52, and includes a flange face 21 and a supporting bib 20. The flange face 21 includes a ring shaped (e.g., washer-shaped) body with a center hole that defines the second opening 19B of the takeoff 5, which is fluidly connected with the air tunnel 19. The ring-shaped body of the flange face 21 further defines a plurality of slots 21A extending therethrough and being distributed in a circumferential manner around the ring-shaped body. See, e.g., FIG. 2A.

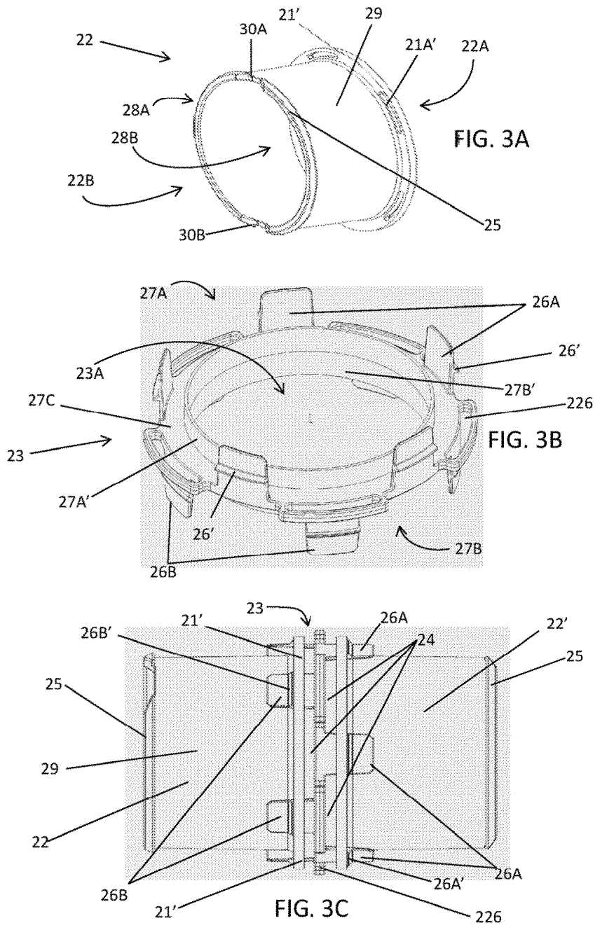

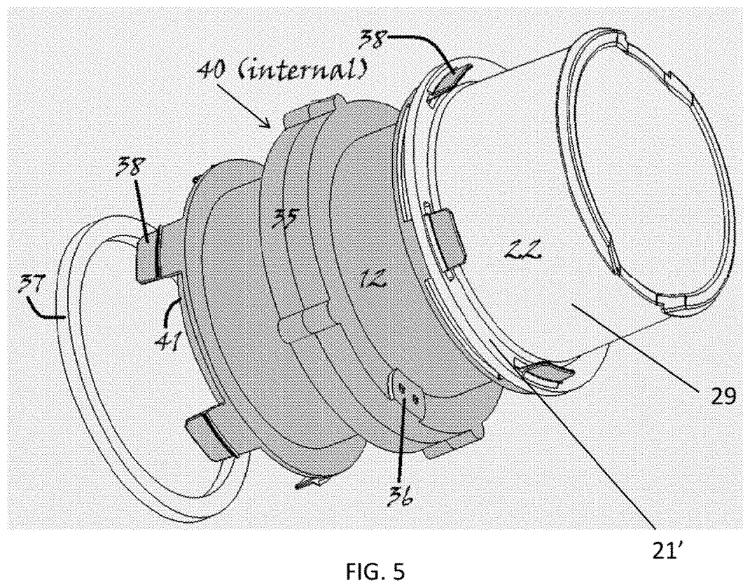

Each slot of the plurality of slots 21A is configured to receive a respective retention stanchion of an end coupler stabilizer (e.g., end coupler stabilizer 23, discussed in more detail below with respect to FIG. 3B, 3C), which in turn connects to an end coupler (e.g., end coupler 22) attached to flexible ducting 52 (such as flexible section 52F shown in FIG. 1) or to an indoor air quality (IAQ) active device (IAQ 12 shown in FIG. 1, or IAQ 40 shown in FIG. 5), discussed in more detail with respect to FIG. 5). Similar to above, with respect to the plurality of slots 17A of the base 17B of the takeoff, a plurality of retention stanchions (each with a respective barb) of the end coupler stabilizer 23 is configured to be inserted into the plurality of slots 21A in the flange face 21. Once a barb of a respective retention stanchion passes through a respective slot, it latches, hooks, or otherwise secures the flange face 21 of the takeoff 5 to the end coupler.

The supporting bib 20 extends from an outer periphery of the flange face 21 such that when the takeoff 5 is positioned on the duct 3, the bib 20 is parallel with a wall of the duct. For example, as depicted in FIG. 2A, the base 17B of the takeoff 5 is positioned on a top wall 3A of the surface 51 of the duct 3, and the bib 20 extends from the flange face 21 and is parallel with a side wall 3B of the surface 51 of the duct 3. The bib 20 also defines a hole 20A therethrough configured to receive a securing device (not shown), such as a screw, which is used to secure and support the takeoff 5. In the embodiment of FIG. 2A, the securing device secures (and supports) the takeoff, via the bib 20, to the side wall 3B of the surface 51 of the duct 3.

Once the first end portion 5A of the takeoff 5 is securely connected to the duct, via the stabilizer 13 (discussed above), and the second end portion 5B of the takeoff is coupled to, for example, the first section 52A of the plurality of ducting sections 52 (as discussed above), air passes from the metal duct 3, through the first opening (not shown) of the first end portion 5A of the takeoff 5, via a stabilizer 13, through the air tunnel 19 of the takeoff 5, continuing through second opening 19B of the second end portion 5B (including, e.g., the flange face 21) to the rest of the system of connectors.

### The End Coupler

FIG. 3A depicts an end coupler, in accordance with exemplary embodiments. As discussed above with respect to FIGS. 2A-2B, the flanged face 21 of the takeoff 5 is configured to connect to an end coupler stabilizer 23 (shown in FIG. 3B), which in turn, is configured to connect to an end coupler 22 (which may be attached to flexible ducting 52) or to an IAQ active device (IAQ 12 shown in FIG. 1, or IAQ 40 shown in FIG. 5), discussed in more detail with respect to FIG. 5).

End couplers are configured to attach to both ends of length of flexible ducting 52 and may be of any suitable size and/or shape. For example, in some exemplary embodiments, a straight end coupler may be used, such as end coupler 22 in FIGS. 1, 3A, 4 and 5. In other exemplary embodiments, a tee shape (T-type) end coupler may be used, such as end coupler 11A in FIG. 1. In other exemplary embodiments, a wye type (Y-type) end coupler (not depicted) may be used. In yet other exemplary embodiments, a 45/90 degree coupler may be used, such as end coupler 11B in FIG. 1.

An end coupler, such as end coupler 22, includes a first end portion 22A defining a first opening (not shown), a second end portion 22B defining a second opening 28A, and a neck portion 29 extending between the first end portion 22A and the second end portion 22B and defining a through-hole 28B between the first opening and the second opening 28A. End coupler 22 may be, for example, of a cylindrical shape (as depicted in FIGS. 3A and 3C), though not limited thereto.

The first end portion 22A of the end coupler 22 includes a flange face 21′. The flange face 21′ is similar to the flange face 21 of the takeoff 5 described above with respect to FIG. 2. In particular, the flange face 21′ includes a ring shaped (e.g., washer-shaped) body with a center hole (not depicted in FIG. 3A) that defines the first opening of the end coupler 22, which is fluidly connected with the through-hole 28B defined by the coupler neck 29. The ring-shaped body of the flange face 21′ extends orthogonally along an outer circumference of the neck portion 29 and further defines a plurality of slots 21A′ extending therethrough and being distributed in a circumferential manner around the ring-shaped body. See, e.g., FIG. 3A.

Each slot of the plurality of slots 21A′ defined by the flange face 21′ of the end coupler 22 is configured to receive a respective retention stanchion of an end coupler stabilizer 23 (discussed in detail below with respect to FIG. 3B), which in turn connects to another end coupler (e.g., end coupler 22′). The other end coupler may be attached to flexible ducting 52 or to an indoor air quality (IAQ) active device (IAQ 12 shown in FIG. 1, or IAQ 40 shown in FIG. 5), discussed in more detail with respect to FIG. 5). Similar to above, with respect to the plurality of slots 17A of the base 17B of the takeoff 5, and the plurality of slots 21A of the flange face 21 of the takeoff 5, a plurality of retention stanchions 26 (26A, 26B), each with a respective barb 26′, of an end coupler stabilizer 23 is configured to be inserted into the plurality of slots 21A′ in the flange face 21′ of the end coupler 22. Once a barb 26′ of a respective retention stanchion passes through a respective slot 21A′, it latches, hooks, or otherwise secures the flange face 21′ of the end coupler 22 to the end coupler stabilizer 23.

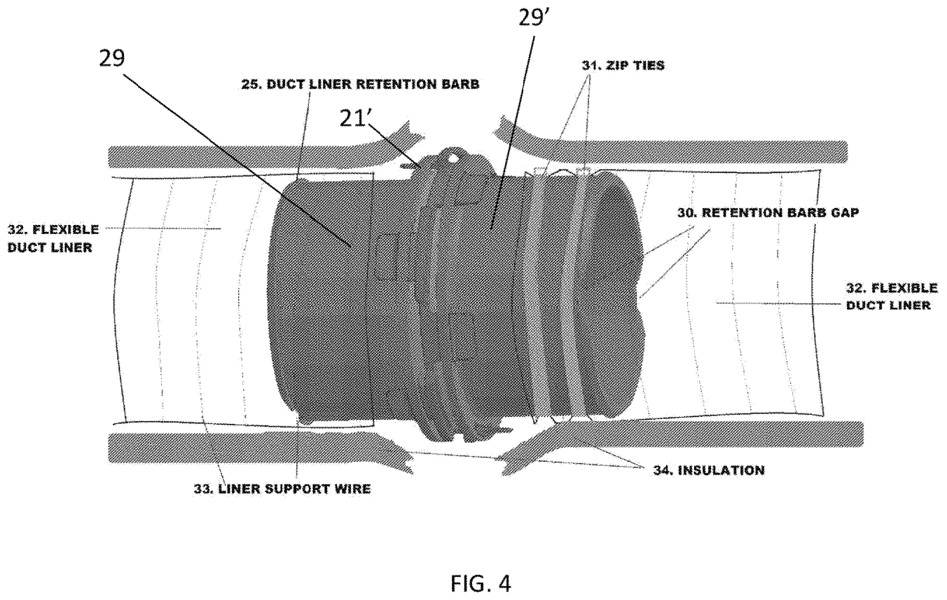

The second end portion 22B of the end coupler 22 is configured to be inserted into a duct liner of a section of ducting, such as flexible duct liner 32 shown in FIG. 4, and includes a duct liner retention barb 25 configured to secure the duct liner 32 such that the duct liner 32 does not slip off the coupler neck 29 of the end coupler 22. The duct liner retention barb 25 (also referred to as a “lip”) is a rounded, raised portion along an edge of the second end portion 22B and includes a gap portion therein configured to receive liner support wire 33 (shown in FIG. 4). The gap portion includes a first gap 30A and a second gap 30B disposed 180 degrees (e.g., directly opposite) the first gap 30A along the circumference of the duct liner retention barb 25.

To secure a flexible duct section to an end coupler, as shown in FIG. 4, a length of flexible duct is first cut (e.g., on both ends), and insulation (e.g., insulation shell 34) is pulled back to expose the duct liner 32. The duct liner 32 is then pulled onto an end coupler neck (e.g., coupler neck 29 of end coupler 22 of FIG. 3A). Said another way, the second end portion 22B of the end coupler 22 is inserted into the duct liner 32 such that the duct liner 32 surrounds an exterior of the second end portion 22B and at least a portion of the coupler neck 29. Similarly, duct liner 32 is pulled onto end coupler neck 29′ (e.g., of end coupler 22′). A liner support wire 33 is aligned to fit between the retention barb gaps 30A, 30B (instead of over the barb), which significantly reduces the chances of slippage of the liner from the neck. The duct liner 32 is then secured by a fastening device 31 to the coupler neck 29 in a location between the duct liner retention barb 25 and the flange face 21′, preferably to the coupler neck 29 closer to the retention barb 25. The fastening device 31 secures the liner support wire 33 tight to the barb while enabling the liner support wire 33 to pass through the barb. As a result, the liner support wire 33 functions as a stop against the barb above the barb. Similarly, duct liner 32 is secured by a fastening device 31 to coupler neck 29′ (e.g., of end coupler 22′) in a location between the duct liner retention barb and the flange face (e.g., of end coupler 22′). The fastener device 31 may be a cable tie (also known as wire tie, hose tie, steggel tie, zap strap or zip tie), for example. However, other suitable fastening devices may be used and would be apparent to those skilled in the art. While the fastening device 31 secures the duct liner 32 to the coupler neck 29, the retention barb 25 prevents the duct liner 32 from slippage along and/or off the coupler neck 29. An adhesive may then be used to adhere the insulation shell 34 to the coupler neck 29 forming a seal of insulation around the end coupler neck 29. Such an adhesive may include, for example, an approved HVAC tape, such as aluminum tape (not shown).

### End Coupler Stabilizer

The end coupler stabilizer 23 (as depicted in FIG. 3B) is configured to securely connect two HVAC system components together. For example, in some embodiments, an end coupler stabilizer 23 may connect one end coupler (e.g., end coupler 22 in FIG. 3C) to another end coupler (e.g., end coupler 22′ in FIG. 3C). In other embodiments, end coupler stabilizer 23 may connect an end coupler (e.g., end coupler 22 in FIG. 3B) to a takeoff (e.g., takeoff 5 of FIG. 2A).

The end coupler stabilizer 23 while depicted as ring-shaped in FIG. 2B, may be of any size and shape suitable for connection to other HVAC components. For example, the end coupler stabilizer may be square shaped and may be configured to securely connect to a suitable square shaped HVAC component. Moreover, while configured to securely connect HVAC system components, the end coupler stabilizer 23 may be detached (when desired) from the components (e.g., decouple components) by a press-release (e.g., thumb-release) mechanism in order to easily change components, incorporate additional components (e.g., such as smart components), etc.

The end coupler stabilizer 23 includes a first end portion 27A, a second end portion 27B, and a central flange portion 27C and defines a through-hole 23A, which gives the end coupler stabilizer 23 its ring-shape. The first end portion 27A of the end coupler stabilizer 23 includes a first male protrusion 27A′ and plurality of retention stanchions 26A, both extending outwardly from the central flange portion 27C.

The first male protrusion 27A′ of the end coupler stabilizer 23 is also ring-shaped and extends orthogonally and outwardly from an inner circumference of the central flange portion 27A in the first direction (e.g., in the direction of the first end portion 27A) and is configured to be inserted into the first opening (not shown) defined by the first end portion 22A of the end coupler 22 and into the through-hole 28B of the end coupler 22. The first male protrusion 27A′ helps define the through-hole 23A through a middle portion of the stabilizer 23.

The second male protrusion 27B′ of the second end portion 27B of the end coupler stabilizer 23 is also ring-shaped and extends orthogonally and outwardly from an inner circumference of the central flange portion 27A in the second direction, opposite the first direction, (e.g., direction of the second end portion 27B) and is configured to be inserted into, for example, the first opening defined by the first end portion of another end coupler (e.g., end coupler 22′ of FIG. 3C) and into a through-hole of the end coupler 22′. The second male protrusion 27B′ (like the first male protrusion 27A′) helps define the through-hole 23A through a middle portion of the stabilizer 23

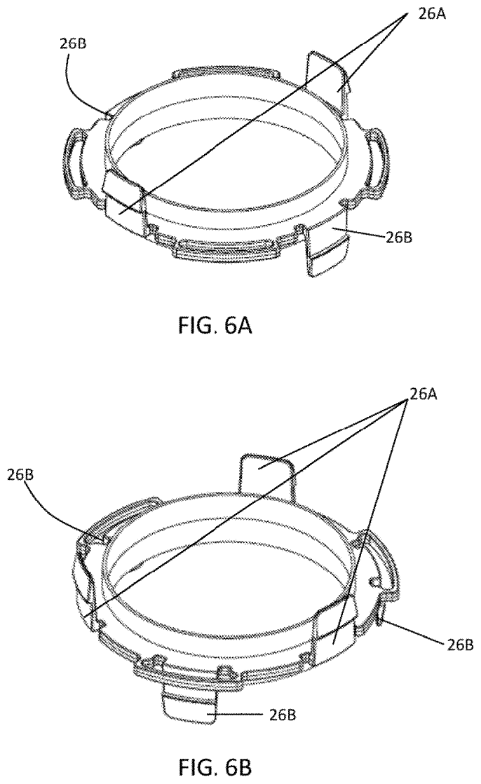

The plurality of retention stanchions 26A, 26B extend orthogonally and outwardly from an outer circumference of the central flange portion 27C in respective directions of the first and second end portions 27A, 27B of the coupler stabilizer 23 and, thus, in a direction parallel to the male protrusions 27A′, 27B′. In particular, as shown in FIG. 3B, first retention stanchions 26A extend orthogonally and outwardly from an outer circumference of the central flange portion 27C in a first direction (e.g., in a direction of the first end portion 27A of the coupler stabilizer 23) and in a direction parallel to the first male protrusion 27A. Second retention stanchions 26B extend orthogonally and outwardly from an outer circumference of the central flange portion 27C in a second direction, opposite the first direction, (e.g., in a direction of the second end portion 27B of the coupler stabilizer 23) and in a direction parallel to the second male protrusion 27B. The first and second retention stanchions 26A, 26B are further disposed (evenly or unevenly) along the outer circumference of the central flange portion 27A of the end coupler stabilizer 23. See, e.g., FIG. 3B. The end coupler stabilizer 23 may include any number of retention stanchions. In some embodiments, for example, each end portion (first end portion 27A and second end portion 27B) may include five retention stanchions (e.g., five first retention stanchions 26A and five second retention stanchions 26B), as depicted in FIG. 3B. In other embodiments, for example, each end portion may include two retention stanchions (e.g., two first retention stanchions 26A and two second retention stanchions 26B), as depicted in FIG. 6A. In yet other embodiments, for example, each end portion may include three retention stanchions (e.g., three first retention stanchions 26A and three second retention stanchions 26B), as depicted in FIG. 6B.

The central flange portion 27C of the stabilizer 23 further comprises gaskets 24 (shown in FIG. 3C) and a plurality of hanger hoops 226 (shown in both FIGS. 3B and 3C). The gaskets 24 (shown in FIG. 3C) are disposed on a first side of the central flange portion 27C and a second side of the central flange portion 27C (i.e., both sides thereof) and maintain compression pressure horizontally on the stanchions 26A, 26B insuring a locked connection when properly inserted into respective slots on a flanged face of another connector (e.g., coupler). The gaskets 24 also maintain vertical compression pressure holding the connecting flange of another connector tight to the barb 26′ on the end of the stanchions.

The plurality of hanger hoops 226 are formed in the central flange portion 27C such that the hoops 226 are orthogonal to the plurality of retention stanchions 26A, 26B and the first and second male protrusions 27A′, 27B′. Each hanger hoop from the plurality of hanger hoops is configured to support lengths of flexible ducting. In particular, the hanger hoops are configured to fit with hanger strapping and secure to beams, floors, etc. By strapping through the stabilizer 23 (via the hanger hoops), the flexible duct is not compromised to inhibit airflow.

The plurality of retention stanchions of the end coupler stabilizer 23 are configured to be inserted into the plurality of slots of, for example, a respective connector (e.g., end coupler, takeoff, etc.). For example, as depicted in FIG. 3C, end coupler stabilizer 23 connects two end couplers (e.g., end coupler 22 and end coupler 22′). To securely connect the two couplers to the end coupler stabilizer and, in turn, to connect the two couplers together, the second retention stanchions 26B of the end coupler stabilizer 23 are inserted into respective slots (not shown) defined in the flange face 21′ of end coupler 22′ such that the barbs 26B′ of each of the second retention stanchions 26B secure the end coupler stabilizer 23 to the end coupler 22.

The first retention stanchions 26A of the end coupler stabilizer 23 are similarly inserted into respective slots (not shown) defined in a flange face of end coupler 22′ such that the barbs 26A′ of each of the first retention stanchions 26A secure the end coupler stabilizer 23 to the end coupler 22′

Gaskets 24, which are disposed on the central flange portion of the end coupler stabilizer 23 maintain compression pressure horizontally on the stanchions 26A, 26B insuring a locked connection the end coupler stabilizer 23 and end couplers 22, 22′. The gaskets 24 also maintain vertical compression pressure holding the connecting flange (e.g., flange 21′ of coupler 22) to the barb on the ends of the retention stanchions.

While FIG. 3C, and associated text, describes connection between the end coupler stabilizer 23 and end couplers 22, 22′, the end coupler stabilizer 23 may be similarly couple any connector (e.g., takeoff, coupler, IAQ active device) together. For example, end coupler stabilizer 23 may connect a coupler (e.g., coupler 22) to a takeoff (e.g., takeoff 5 depicted in FIG. 2A) by inserting retention stanchions of the end coupler stabilizer 23 into respective slots of the end coupler and into respective slots (e.g., slots 21A) defined in a flange face (flange face 21) of the takeoff. End coupler stabilizer 23 may also connect, for example, a takeoff to an IAQ active device.

FIG. 5 illustrates connection of an active device 40 (e.g., Indoor Air Quality (IAQ)) to an end coupler 22. Similar to the end coupler stabilizer 23 described above, the active device 40 includes a plurality of retention stanchions 38, each retention stanchion including a barb, and a male protrusion 41. Each retention stanchion 38 is configured to be aligned with and inserted into a respective slot of the flange face 21′ of the end coupler until the barb of each retention stanchion snaps over the lip of the slot, compressing a device gasket 37 and inserting the male protrusion into the through-hole defined by the neck 29 of the end coupler 22.

The active device 40, which is activated by snapping into the system, is encased (in an encasement 12) in a device compartment 35 where it is powered by connecting to a low voltage power source plugged into the 2-prong low voltage power socket 36. The encasement 12 may include, for example, a booster fan, a damper, a smoke and gas alarm, an ionic air sweep, etc. The power for the encasement 12 originates from the beginning of the system (e.g., takeoff) or from the end of the system (e.g., register boot). The other end of the active device 40 in turn is configured to similarly connect to another end coupler.

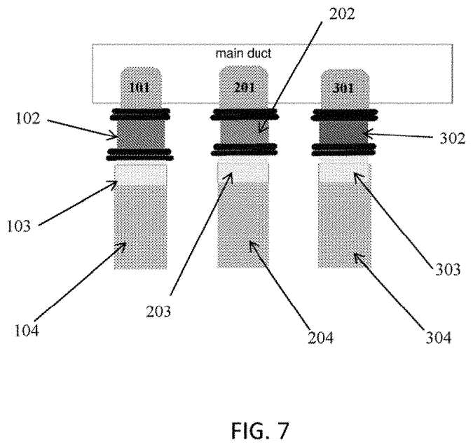

FIG. 7 illustrates a duct, device and zone relationship in accordance with exemplary embodiments. Each of a plurality of active devices 102, 202, and 302 is configured to snap into a respective takeoff 101, 201, and 301. For example, as depicted, active device 102 is configured to snap into takeoff 101, active device 202 is configured to snap into takeoff 201, and active device 302 is configured to snap into takeoff 301. Each of a plurality of end couplers 103, 203, and 303 is configured to snap (e.g., connect) a respective flexible duct length 104, 204, and 304 to the respective active devices 102, 202 and 302. For example, end coupler 103 snaps flexible duct length 104 to active device 102, end coupler 203 snaps flexible duct length 204 to active device 202, and end coupler 303 snaps flexible duct length 304 to active device 302.

Each of the depicted takeoffs 101, 201, and 301 may represent an airway to a zone, or room in a building. Each of the active devices 102, 202, and 302 may be interchangeable. For example, active device 102 can be changed with active device 202 or 302. For example, active device 102 may be a smoke and gas alarm, and active device 202 may be an active device sweep. These active devices may be switched/interchanged such that the active device sweep (and not the smoke and gas alarm) is connected to takeoff 101 and end coupler 103. Similarly, more than one of the same active device may be installed. For example, active device 102 and 202 may be the same active device, or active device 202 and 302 may be the same device. To be interchangeable, however, a low voltage power must be run to the takeoffs. Thus, when the devices snap in (e.g., are connected), they are immediately powered.

Furthermore, if each of the takeoffs 101, 201, and 301 represent respective zones, a respective connected active device identifies as part of the respective zone. Thus, each of the plurality of takeoffs 101, 201, and 301 not only power a respective active device, but they also identify the respective active device as part of the respective zone. In other words, each of the takeoff 101, 201, and 301 are configured to intelligently convey to a respective active device and a hub, and the hub would control the active device as it relates to a respective zone. For example, the hub could command a booster fan to activate, unless a damper at the beginning of the zone was closed.

Techniques consistent with the present disclosure provide, among other features, a system and method of connectors configured to connect flexible ducting to a plenum and distribute air to multiple distribution points. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed:

1. A stabilizer component configured to securely couple two heating, ventilating and air conditioning (HVAC) system components together, the stabilizer component comprising:
a unitary body including a central flange (i) defining an through-hole from a first end portion of the stabilizer component to a second end portion of the stabilizer component, and (ii) including an inner circumference and an outer circumference,
a plurality of first retention stanchions, wherein each first retention stanchion (i) extends orthogonally and outwardly from the outer circumference of the central flange in a first direction, and (ii) is configured to be inserted into a respective receiving slot of a first HVAC connecting component; and
a plurality of second retention stanchions, wherein each second retention stanchion (i) extends orthogonally and outwardly from the outer circumference of the central flange in a second direction, said second direction being opposite said first direction, and (ii) is configured to be inserted into a respective receiving slot of a second HVAC connecting component.

2. The stabilizer component according to claim 1, further comprising:
a first male protrusion extending orthogonally and outwardly from an inner circumference of the central flange in the first direction, wherein said first male protrusion further defines the through-hole and is configured to be inserted into a center opening defined by the first HVAC connecting component.

3. The stabilizer component according to claim 2, further comprising:
a second male protrusion extending orthogonally and outwardly from the inner circumference of the central flange in the second direction, wherein said second male protrusion further defines the through-hole and is configured to be inserted into a center opening defined by the second HVAC connecting component.

4. The stabilizer component according to claim 1, further comprising:
a plurality of hanger hoops formed in the central flange portion such that the hoops 226 are orthogonal to the plurality of first and second retention stanchions, wherein said plurality of hanger hoops is configured to support lengths of flexible ducting.

5. The stabilizer component according to claim 1, wherein each retention stanchion of the plurality of first and second retention stanchions includes a barb component disposed on a distal end portion thereof configured to secure a respective retention stanchion to a flange face of a respective HVAC connecting component upon insertion of the respective retention stanchion into a respective receiving slot of the respective HVAC connecting component.

6. The stabilizer component according to claim 1, wherein the stabilizer component is ring-shaped.

7. The stabilizer component according to claim 1, wherein the stabilizer component is comprised of a plastic material.

8. The stabilizer component according to claim 1, further comprising:
a first gasket disposed on a first side of the central flange between the first male protrusion and the plurality of first retention stanchions and configured to insure a locked connected between the first end portion of the stabilizer component and the first HVAC connecting component.

9. The stabilizer component according to claim 8, further comprising:
a second gasket disposed on a second side of the central flange between the second male protrusion and the plurality of second retention stanchions and configured to insure a locked connected between the second end portion of the stabilizer component and the second HVAC connecting component.

10. The stabilizer component according to claim 1, wherein
the first HVAC connecting component includes one of a takeoff, end coupler, T-couplers, Wye couplers, 90-degree coupler, 45-degree coupler, end cap, register boot, register, and electrified coupler, and
the second HVAC connecting component includes one of a takeoff, end coupler, T-couplers, Wye couplers, 90-degree coupler, 45-degree coupler, end cap, register boot, register, and electrified coupler.

11. A takeoff configured to transfer air from a duct section extending from a plenum of a heating, ventilating and air conditioning (HVAC) system to a plurality of flexible ducting section, the takeoff comprising:
a first base portion removably connected to a first section of ducting of a plurality of ducting sections, said front base including a flange face defining a center hole and further defining a plurality of slots extending therethrough, wherein each slot of the plurality of slots defined by the first base portion is configured to receive a respective retention stanchion of stabilizer component;
a second base portion aligned over an opening defined in a surface of the duct section extending from the plenum and removably coupled to the surface; and
a throat portion extending between the first base portion and the second base portion and defining an air tunnel from the center hole of the first base portion to the opening defined in the surface of the duct section, wherein
the second base portion is disposed orthogonally to and extending from the throat portion and defines a plurality of slots, each slot of the plurality of slots defined by the second base portion being configured to receive a respective retention stanchion of a stabilizer component, said stabilizer component having a unitary body that connects from within and below the surface of the duct section.

12. The takeoff according to claim 11, wherein the flange face includes a ring shaped body that defines the plurality of slots of the first base portion.

13. The takeoff according to claim 11, wherein the first base portion further includes a supporting bib that extends from an outer periphery of the flange face and is disposed parallel with a side wall of the duct section.

14. The takeoff according to claim 13, wherein the supporting bib defines a hole therethrough configured to receive a securing device for securing the takeoff, via the bib, to the side wall of the duct section.

15. An end coupler component removably coupleable to two heating, ventilating and air conditioning (HVAC) system components, the end coupler component comprising:
a first end portion including a flange face and defining a first opening;
a second end portion opposite said first end portion and defining a second opening; and
a neck portion extending between the first end portion and the second end portion and defining a through-hole fluidly connected between the first opening defined by the first end portion and the second opening defined by the second end portion, wherein
the flange face of the first end portion extends along an outer circumference of the neck portion and defines a plurality of slots, each slot of the plurality of slots being configured to receive a respective retention stanchion of a stabilizer component, and
the second end portion is configured to be inserted into a duct liner of a section of flexible ducting such that the duct liner covers an outer periphery of at least a portion of the neck portion.

16. The end coupler component of claim 15, further comprising:
a duct liner retention barb disposed along an outer circumference of the neck portion at the second end portion of the end coupler, wherein said duct liner retention barb is configured to secure the duct liner to the neck portion.

17. The end coupler component of claim 16, wherein duct liner retention barb includes a gap portion therein configured to receive a liner support wire, said gap portion includes a first gap and a second gap disposed directly opposite said first gap.

18. The end coupler component of claim 15, wherein the flange face defines a ring shaped body.

19. A system for distribution of air from a central plenum to multiple distribution points, said system comprises:
a stabilizer component including (i) a plurality of first retention stanchions extending orthogonally and outwardly from an outer circumference of a central flange in a first direction, and (ii) a plurality of second retention stanchions extending orthogonally and outwardly from the outer circumference of the central flange in a second direction;
a takeoff component including
a flange face defining a plurality of slots extending therethrough, wherein each slot of the plurality of slots defined by the flange face is configured to receive a respective first retention stanchion of the plurality of first retention stanchions of the stabilizer component, and
a base portion aligned over an opening defined in a surface of the duct section extending from the plenum and removably coupled to the surface, and
an end coupler component including
a first end portion defining a plurality of slots, each slot of the plurality of slots of the end coupler component being configured to receive a respective second retention stanchion of the plurality of second retention stanchions of the stabilizer component, and
a second end portion configured to be inserted into a duct liner of a section of flexible ducting.
